(19) United States
(12) Patent Application Publication
(10) Pub. No.: US 2019/0236534 A1
(43) Pub. Date: Aug. 1, 2019

(54) DELIVERY VEHICLE, MOBILE SALE SYSTEM, AND MOBILE SALE MANAGEMENT METHOD EXECUTED BY DELIVERY VEHICLE AND SERVER

(71) Applicant: Toyota Jidosha Kabushiki Kaisha, Toyota-shi Aichi-ken (JP)

(72) Inventors: Yusuke Kaneko, Nagoya-shi Aichi-ken (JP); Masato Endo, Nagakute-shi Aichi-ken (JP); Shinji Sassa, Ama-shi Aichi-ken (JP); Takahiro Shiga, Chiryu-shi Aichi-ken (JP); Yohei Tanigawa, Toyota-shi Aichi-ken (JP)

(73) Assignee: Toyota Jidosha Kabushiki Kaisha, Toyota-shi Aichi-ken (JP)

(21) Appl. No.: 16/260,514

(22) Filed: Jan. 29, 2019

(30) Foreign Application Priority Data
Jan. 31, 2018 (JP) 2018-015003

(51) Int. Cl. G06Q 10/08; G05D 1/02; H04W 4/40; H04W 4/02

(52) U.S. Cl. CPC G06Q 10/0832; G06Q 10/087; G06Q 10/08355; H04W 4/027; G05D 1/021; H04W 4/40; G06Q 10/0833

(57) ABSTRACT

A delivery vehicle includes: a moving unit configured to move the delivery vehicle from a current position to a delivery destination; a manufacturing device configured to manufacture a product; and circuitry configured to receive a delivery instruction to deliver the product to the delivery destination, acquire the current position of the delivery vehicle, estimate an expected arrival time for the delivery vehicle to arrive at the delivery destination based on the current position and the delivery destination, and control the manufacturing device such that the expected arrival time and a manufacturing completion time of the product match each other.

### CROSS-REFERENCE TO RELATED APPLICATION

This application claims priority to Japanese Patent Application No. 2018-015003 filed on Jan. 31, 2018, incorporated herein by reference in its entirety.

### BACKGROUND

### 1. Technical Field

The disclosure relates to a delivery vehicle, a mobile sale system, and a mobile sale management method executed by a delivery vehicle and a server.

### 2. Description of Related Art

A mobile sale using a vehicle has been used in the related art. In the mobile sale, products exemplified by bread, sushi, and the like are loaded on the vehicle, and the products are sold at a destination of the vehicle. Examples of the vehicle used for the mobile sale include a vehicle which includes cooking facilities such that a cooking is possible inside the vehicle or a vehicle which preserves foods and cooking ingredients in preserving facilities such as refrigerators such that deterioration of the foods and the cooking ingredients can be suppressed (for example, Japanese Registered Utility Model No. 3000542, Japanese Unexamined Patent Application Publication No. 09-299017 (JP 09-299017 A), Japanese Unexamined Patent Application Publication No. 09-150665 (JP 09-150665 A), Japanese Unexamined Patent Application Publication No. 08-026017 (JP 08-026017 A)).

### SUMMARY

However, in the mobile sale of the related art, usually, the products cooked in advance are sold. Further, even in a case where the vehicle including the cooking facilities is used to provide fresh-cooked products for the mobile sale, customers need to wait until the cooking is completed, or the customers need to be notified of an expected time of a cooking completion and need to be asked to pay a visit at the expected time. In the mobile sale, it is difficult to provide the customers with the fresh-cooked products.

Therefore, the disclosure provides a delivery vehicle, a mobile sale system, and a mobile sale management method that realizes a mobile sale which can provide customers with fresh-cooked products.

A first aspect of the disclosure a delivery vehicle including: a moving unit configured to move the delivery vehicle from a current position to a delivery destination; a manufacturing device configured to manufacture a product; and circuitry configured to receive a delivery instruction to deliver the product to the delivery destination, acquire the current position of the delivery vehicle, estimate an expected arrival time for the delivery vehicle to arrive at the delivery destination based on the current position and the delivery destination, and control the manufacturing device such that the expected arrival time and a manufacturing completion time of the product match each other.

According to the first aspect of the disclosure, the delivery vehicle is configured to estimate the expected arrival time for the delivery vehicle to arrive at the delivery destination and control the manufacturing of the product such that a manufacturing completion time of the product and the expected arrival time match each other. An expression that the manufacturing completion time of the product and the expected arrival time match each other is not limited to a case where the manufacturing completion time of the product coincides with the expected arrival time and includes a case of a slight deviation. Further, the control includes controlling the manufacturing completion time of the product to be as close as possible to the expected arrival time. By performing such a control, it is possible to provide fresh-cooked products to an orderer of the product waiting at the delivery destination.

In the delivery vehicle according to the first aspect of the disclosure, the circuitry may be configured to acquire the current position of the delivery vehicle and estimate the expected arrival time when the delivery vehicle receives the delivery instruction.

In the delivery vehicle according to the first aspect of the disclosure, the circuitry may be configured to change a time at which the manufacturing device starts the manufacturing of the product based on a manufacturing time of the product and the expected arrival time such that the expected arrival time and the manufacturing completion time of the product match each other. In the delivery vehicle according to the first aspect, the circuitry may be configured to change a time to be spent on at least one step among product manufacturing steps such that the expected arrival time and the manufacturing completion time of the product match each other.

In the first aspect, the product may be bread, the manufacturing device may include an oven that bakes bread dough and the circuitry may configured to change a temperature and a cooking time of the oven for a baking loss rate of the bread dough to fall within a desired range such that the expected arrival time and the manufacturing completion time of the product match each other. According to the above configuration, it is possible to match the manufacturing completion time of the bread and the expected arrival time while suppressing a change in a texture of the bread.

The delivery vehicle according to the first aspect may include a payment receiving unit configured to receive a payment of a product price, and the circuitry may be configured to suppress a handing over of the product by the delivery vehicle until the payment receiving unit receives the payment of the product price. According to the above configuration, a non-payment of the price is suppressed by suppressing the handing over of the product until the payment receiving unit receives the payment of the price.

The delivery vehicle according to the first aspect of the disclosure may further include a display configured to display at least one of information for specifying the product, an inventory quantity of the product, and an expected manufacturing completion time of the product, the display being provided on an outer wall of the delivery vehicle. According to the above configuration, by displaying such information on the display, for example, it is possible to provide a user or a person around the delivery vehicle with information on the products handled by the delivery vehicle and make the user or the person around the delivery vehicle want to buy the product.

A second aspect of the disclosure a mobile sale system including: a server; and one or more delivery vehicles. The server includes a memory that stores a management table in which a product is associated with each delivery vehicle among the one or more delivery vehicles, and a processor configured to receive order information including information for specifying the product and information indicating a delivery destination from a user device, specify a delivery vehicle that handles the product specified by the order information among the one or more delivery vehicles with reference to the management table, and transmit a delivery instruction including the order information to the specified delivery vehicle. Each of the one or more delivery vehicles includes a manufacturing device configured to manufacture the product, a moving unit configured to move the delivery vehicle from a current position to the delivery destination, a receiving unit configured to receive the delivery instruction, and an electronic control unit configured to acquire the current position of the delivery vehicle after the delivery instruction is received, estimate an expected arrival time for the delivery vehicle to arrive at the delivery destination based on the current position and the delivery destination, and control the manufacturing device such that the expected arrival time and a manufacturing completion time of the product match each other.

A third aspect of the disclosure provides a mobile sale management method executed by a delivery vehicle and a server. The delivery vehicle includes a manufacturing device configured to manufacture a product, the server is configured to receive order information including information for specifying the product and information indicating a delivery destination from a user device and to communicate with the delivery vehicle. The mobile sale management method includes: (a) acquiring a current position of the delivery vehicle; (b) estimating an expected arrival time for the delivery vehicle to arrive at the delivery destination based on the current position and the delivery destination; (c) causing the delivery vehicle to move to the delivery destination; and (d) providing the manufacturing device with information for controlling the manufacturing device such that the expected arrival time and a manufacturing completion time of the product match each other.

In the mobile sale management method according to the third aspect of the disclosure, the steps (a), (b), and (d) may be executed by an electronic control unit mounted on the delivery vehicle.

In the mobile sale management method according to the third aspect of the disclosure, the steps (a), (b), and (d) may be executed by an electronic circuit provided in the server.

According to the aspects of the disclosure, it is possible to provide the customers with the fresh-cooked products in the mobile sale.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of a mobile sale system according to an embodiment;

FIG. 2 is a perspective view illustrating an appearance of an EV pallet;

FIG. 3 is a diagram for a plan view illustrating a disposition of a sensor, a display, a driving device, and a control system mounted on the EV pallet as viewed from below the EV pallet;

FIG. 4 is a diagram illustrating a configuration of the control system and each unit related to the control system;

FIG. 5 is a diagram illustrating an example of a cooking system mounted on the EV pallet;

FIG. 6 is a diagram illustrating a hardware configuration of a management server;

FIG. 7 is a block diagram illustrating a logical configuration of the EV pallet;

FIG. 8 is a table illustrating a configuration of a cooking timetable in a processing time database;

FIG. 9 is a table illustrating a configuration of an inventory quantity table in an inventory management database;

FIG. 10 is a block diagram illustrating a logical configuration of the management server;

FIG. 11 is a table illustrating a configuration of a pallet management table in a pallet management database;

FIG. 12 is a table illustrating a configuration of a delivery management table in the pallet management database;

FIG. 13 is a table illustrating a configuration of a product management table in the product management database;

FIG. 14A is a diagram illustrating an example of a screen transition of a user device at the time of a product order;

FIG. 14B is a diagram illustrating an example of the screen transition of the user device at the time of the product order;

FIG. 14C is a diagram illustrating an example of the screen transition of the user device at the time of the product order; and

FIG. 15 is a diagram illustrating an example of a processing sequence of the mobile sale system according to the embodiment.

### DETAILED DESCRIPTION

Hereinafter, a mobile sale system according to an embodiment will be described with reference to the drawings. A configuration of an embodiment described below is an example, and the disclosure is not limited to the configuration of the embodiment.

Regarding EV Pallet

In the embodiment, a self-propelled electrified vehicle called an electric vehicle (EV) pallet links to a computer system on the network to provide a user with various functions or services. The EV pallet of the embodiment (hereinafter simply referred to as the “EV pallet”) is a moving object capable of autonomous driving and driverless driving, and examples of which include ones of various dimensions depending on a usage. For example, various EV pallets are available, from small ones that can be used instead of suitcases to large ones that can transport a person and goods.

The EV pallet also includes an information processing device and a communication device that control the EV pallet, provide a user interface with a user using the EV pallet, and exchange information with various servers on the network. The EV pallet links to the various servers on the network and provides the user with functions and services added by the various servers on the network in addition to processing that can be executed by the EV pallet alone. Further, the EV pallet stores materials of products handled in the mobile sale system according to the embodiment or manufactures the products by processing the stored the materials.

The mobile sale system according to the embodiment may include a plurality of EV pallets, and each of the EV pallets may handle different products. For example, one EV pallet may handle bread as a product, another EV pallet may handle sushi as a product, and the other EV pallet may handle vegetables as a product. Further, the EV pallets may handle the same product.

For example, a server selects the EV pallet that handles an ordered product when a user accesses the server on the network and orders a product. The server transmits a delivery instruction instructing the selected EV pallet to deliver the ordered product. The delivery instruction includes information indicating the ordered product and information indicating a delivery destination. The EV pallet that has received the delivery instruction estimates an expected arrival time to arrive at the delivery destination and manufactures the product to be completed by the expected arrival time estimated during the moving to the delivery destination.

Device Configuration

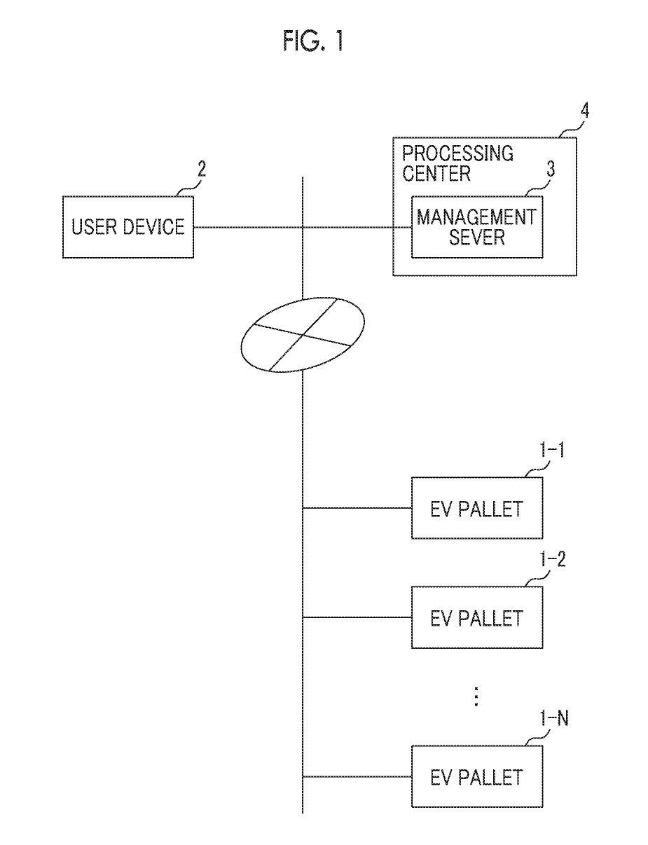

FIG. 1 illustrates a configuration of the mobile sale system according to the embodiment. The mobile sale system according to the embodiment includes the EV pallets 1-1, 1-2, . . . , 1-N and a management server 3 to which the EV pallets 1-1, 1-2, . . . , 1-N are connected via a network N1. Hereinafter, in a case of being collectively referred to without being distinguished individually, the EV pallets 1-1, 1-2, . . . , 1-N are simply referred to as an EV pallet 1. Although the management server 3 is installed in a processing center 4 in FIG. 1, the management server 3 may be installed in a place different from the processing center 4. Further, a user device 2 is connected to the network N1.

The network N1 is a public communication network, and for example, the Internet is exemplified. The network N1 may include a wired communication network and a wireless communication network. The wireless communication network is, for example, a communication network of each mobile phone company. Note that some parts of the wireless communication network may include a wireless local area network (LAN) or the like. Note that the wired communication network is a communication network provided by a communication carrier. Note that the wired communication network may include a wired LAN.

The EV pallet 1 is the moving object capable of an autonomous driving travel and a driverless driving travel for transporting a person or goods. The EV pallet 1 includes a computer-controlled user interface, receives a request from the user, responds to the user, executes a predetermined processing in response to the request from the user, and reports a processing result to the user. For example, the EV pallet 1 receives a user instruction from a voice, an image, or an input and output device of a computer and executes the processing. Further, the EV pallet 1 recognizes the user by the image or the voice of the user and follows the user based on a movement of the user. Further, the EV pallet 1 has a processing facility that processes the material, manufactures the product by processing the material prepared in the processing center 4, and sells the product to the user. The EV pallet 1 is an example of a “delivery vehicle”.

The processing center 4 is a factory that performs the preparation of the materials used for the products handled by the mobile sale system according to the embodiment. For example, in a case where the product handled by the mobile sale system is bread, as a preparation for the bread, the processing center 4 manufactures bread dough and cuts the manufactured bread dough into pieces one by one. Further, in the preparation for the bread to containing ingredients such as cream, fruit, curry roux, or the like inside the bread dough, the processing center 4 also performs a step of adding the ingredients to the inside of the bread dough. The material prepared in the processing center 4 is conveyed into the EV pallet 1.

The user accesses the management server 3 via the user device 2, designates a product type and the delivery destination, and makes an order. In response to the order, the management server 3 selects the EV pallet that handles the ordered product and instructs the selected EV pallet to deliver the ordered product. In the embodiment, the EV pallet 1 selected by the management server 3 which has received the order from the user is referred to as a delivery pallet.

The user device 2 is, for example, a mobile phone, a smartphone, a portable information terminal, a tablet terminal, or a personal computer. The user device 2 receives the request from the user, executes the predetermined processing in response to the request from the user, and reports the processing result to the user. The user device 2, for example, provides the user with a user interface for a product order by accessing the management server 3 or the like on the network N1. Further, the user device 2 acquires a current position based on a detection signal received from the Global Positioning System (GPS).

The management server 3 receives the product order from the user device 2 and selects the EV pallet 1 that delivers the ordered product. Furthermore, the management server 3 links to the user device 2 or the like to improve the service for the user. For example, the management server 3 acquires the expected arrival time at the delivery destination from the delivery pallet and notifies the user device 2 of the acquired expected arrival time. Further, for example, the management server 3 instructs the EV pallet 1 of which the number of the kept materials has become equal to or less than a predetermined quantity, to be supplied with the material.

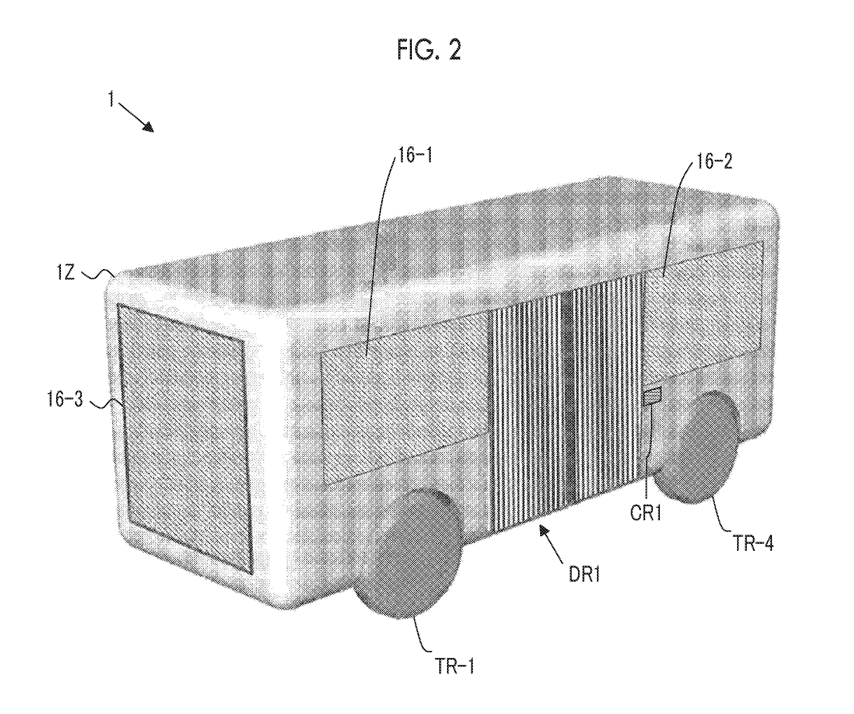

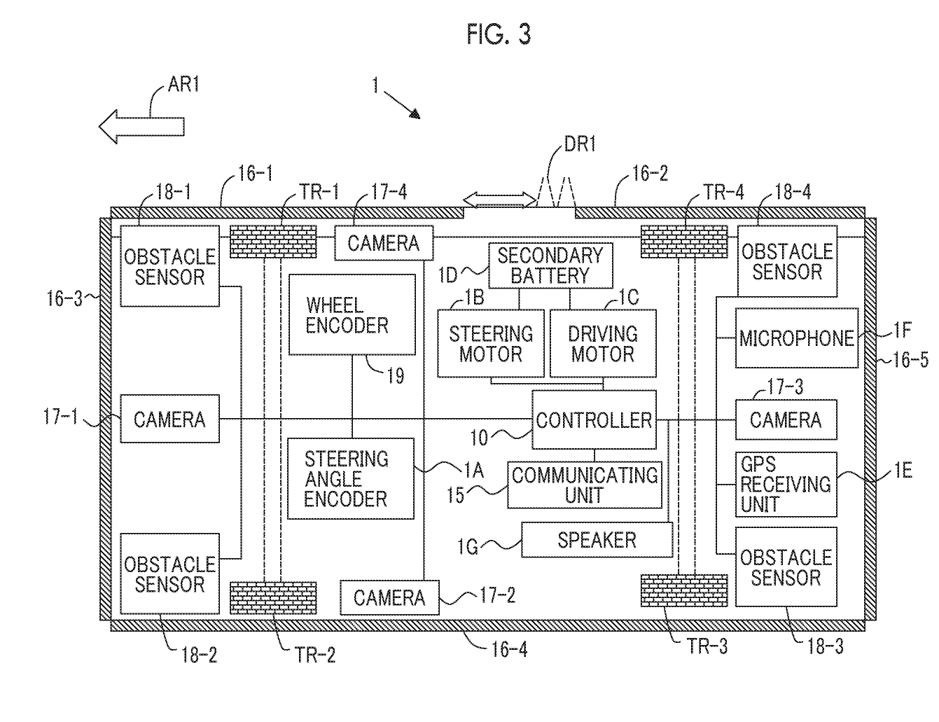

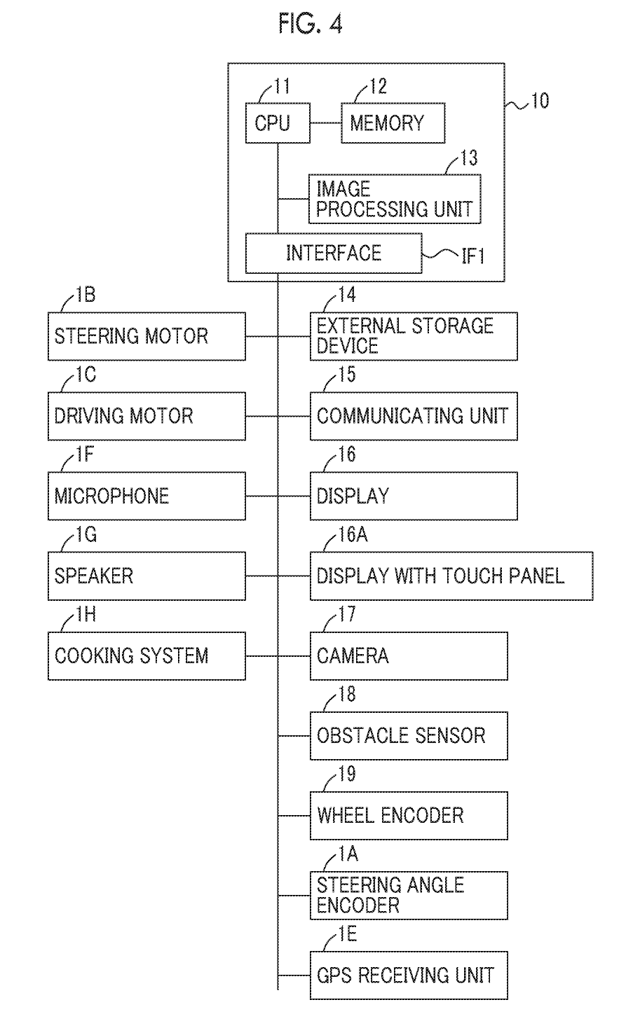

FIG. 2 is a perspective view illustrating an appearance of the EV pallet 1. FIG. 3 is a diagram for a plan view illustrating a disposition of a sensor, a display, a driving device, and a control system mounted on the EV pallet 1 as viewed from below the EV pallet 1. FIG. 4 is a diagram illustrating a configuration of a control system 10 and each unit related to the control system 10.

The EV pallet 1 has a box-shaped body 1Z and four wheels TR1 to TR4 provided at the front and rear on both sides of a bottom portion of the body 1Z with respect to a traveling direction. The four wheels TR1 to TR4 are connected to a drive shaft (not illustrated) and driven by a driving motor 1C illustrated in FIG. 3. Further, the traveling direction of the four wheels TR1 to TR4 during traveling (a direction parallel to rotation surfaces of the four wheels TR1 to TR4) is relatively displaced with respect to the body 1Z by a steering motor 1B illustrated in FIG. 3, and the traveling direction is controlled. An engine may be mounted instead of the driving motor 1C. The number of the wheels is not limited to four and maybe three or five or more as long as the EV pallet 1 is capable of traveling.

As illustrated in FIG. 2 and FIG. 3, displays 16-1 to 16-5 are fixed to the outer wall of the body 1Z of the EV pallet 1. The displays 16-1 to 16-5 are, for example, liquid crystal displays, electroluminescence panels, or the like. In a case of being collectively referred to without being distinguished individually, the displays 16-1 to 16-5 are referred to as a display 16.

A side surface of the EV pallet 1 is provided with a door DR1. The door DR1 is used for loading cargo into an inside of the EV pallet 1, unloading of the cargo from the inside of the EV pallet 1, getting on and off the EV pallet 1 of a person, or the like. A card reader CR1 is provided in the vicinity of the door DR1. The card reader CR1 is a device having a card insertion slot and reads out information from a credit card inserted in the insertion slot to perform a payment processing of a product price. For example, the card reader CR1 transmits read out information to the server that manages the credit card and the payment processing is executed. The card reader CR1 is an example of “payment receiving means”.

In FIG. 3, the EV pallet 1 is assumed to be traveling in the direction of an arrow AR1. Accordingly, a leftward direction in FIG. 3 is assumed to be the traveling direction. Here, in FIG. 3, a side surface of the body 1Z on the traveling direction side is referred to as a front surface of the EV pallet 1, and the side surface opposite the traveling direction is referred to as a rear surface of the EV pallet 1. Further, the side surface on the right side with respect to the traveling direction of the body 1Z is referred to as a right side surface and the side surface on the left side is referred to as a left side surface.

As illustrated in FIG. 3, the EV pallet 1 has obstacle sensors 18-1, 18-2 at positions near a corner portions on both sides at the front surface and has obstacle sensors 18-3, 18-4 at positions near a corner portions on both sides at the rear surface. Further, the EV pallet 1 has cameras 17-1, 17-2, 17-3, 17-4 on the front surface, the left side surface, the rear surface, and the right side surface respectively. In a case of being collectively referred to without being distinguished individually, in the embodiment, the obstacle sensors 18-1, 18-2, 18-3, 18-4 are referred to as an obstacle sensor 18. Further, in a case of being collectively referred to without being distinguished individually, in the embodiment, the cameras 17-1, 17-2, 17-3, 17-4 are referred to as a camera 17.

Further, the EV pallet 1 has the steering motor 1B, the driving motor 1C, and a secondary battery 1D that supplies electric power to the steering motor 1B and the driving motor 1C. Further, the EV pallet 1 has a wheel encoder 19 that detects a rotation angle of a wheel every moment and a steering angle encoder 1A that detects a steering angle which is the traveling direction of the wheel. Further, the EV pallet 1 includes a control system 10, a communicating unit 15, a GPS receiving unit 1E, a microphone 1F, and a speaker 1G. Although not illustrated, the secondary battery 1D also supplies the electric power to the control system 10 or the like. Note that, in addition to the secondary battery 1D that supplies the electric power to the steering motor 1B and the driving motor 1C, a power supply that supplies the electric power to the control system 10 or the like may be provided.

The control system 10 is also referred to as an engine control unit (ECU). As illustrated in FIG. 4, the control system 10 has a central processing unit (CPU) 11, a memory 12, an image processing unit 13, and an interface IF1. The interface IF1 is connected with an external storage device 14, the communicating unit 15, the display 16, a display 16A with a touch panel, the camera 17, the obstacle sensor 18, the wheel encoder 19, the steering angle encoder 1A, the steering motor 1B, the driving motor 1C, the GPS receiving unit 1E, a microphone 1F, the speaker 1G, or the like.

The obstacle sensor 18 is an ultrasonic sensor, a radar, or the like. The obstacle sensor 18 emits ultrasonic waves, electromagnetic waves, or the like in the direction of a detection target and detects a presence, a position, a relative speed, or the like of the obstacle in the direction of the detection target based on reflected waves.

The camera 17 is an imaging device using an image sensor such as Charged-Coupled Devices (CCD), Metal-Oxide-Semiconductor (MOS), Complementary Metal-Oxide-Semiconductor (CMOS), or the like. The camera 17 acquires an image at a predetermined time interval referred to as a frame cycle and stores the acquired image in a frame buffer (not illustrated) in the control system 10. The image stored in the frame buffer at the frame cycle is referred to as frame data.

The steering motor 1B controls the direction of an intersecting line where a rotation surface of the wheel intersects a horizontal surface, that is, an angle which is the traveling direction by the rotation of the wheel, in accordance with an instruction signal from the control system 10. In accordance with the instruction signal from the control system 10, for example, the driving motor 1C drives and rotates the wheels TR1 to TR4. Note that the driving motor 1C may drive a pair of wheels TR1, TR2 or the other pair of wheels TR3, TR4 among the wheels TR1 to TR4. The secondary battery 1D supplies the electric power to the steering motor 1B, the driving motor 1C, and components connected to the control system 10.

The steering angle encoder 1A detects the direction of the intersecting line which is the traveling direction by the rotation of the wheel and where the rotation surface of the wheel intersects the horizontal surface (or the angle of a rotation axis of the wheel in the horizontal surface) at a predetermined detection time interval and stores the detected direction in a register (not illustrated) of the control system 10. For example, an origin of an angle is set in the direction in which the rotation axis of the wheel is orthogonal to the traveling direction (the direction of the arrow AR1) in FIG. 3. Further, the wheel encoder 19 acquires a rotation speed of the wheel at the predetermined detection time interval and stores the rotation speed in the register (not illustrated) of the control system 10.

The communicating unit 15 communicates with various servers or the like on the network N1, for example, through a mobile phone base station and a public communication network connected to the mobile phone base station. The Global Positioning System (GPS) receiving unit 1E receives radio waves of time signals from a plurality of artificial satellites (Global Positioning Satellite) circling the earth and stores the radio waves in the register (not illustrated) of the control system 10. The microphone 1F detects the voice, converts the voice into a digital signal, and stores the digital signal in the register (not illustrated) of the control system 10. The speaker 1G is driven by the control system 10, a digital to analog (D/A) converter, or an amplifier connected to a signal processing unit (not illustrated) and reproduces audio including sound and voice.

The CPU 11 of the control system 10 executes a computer program that is executably deployed in the memory 12 and executes processing as the control system 10. The memory 12 stores the computer program executed by the CPU 11, data processed by the CPU 11, or the like. The memory 12 is, for example, a Dynamic Random Access Memory (DRAM), a Static Random Access Memory (SRAM), a Read Only Memory (ROM), or the like. The image processing unit 13 links to the CPU 11 to process the data of the frame buffer obtained from the camera 17 at for each predetermined frame cycle. The image processing unit 13 has, for example, an image memory to be the frame buffer and a graphics processing unit (GPU). The external storage device 14 is a nonvolatile storage device, for example, a solid state drive (SSD), a hard disk drive, or the like.

For example, as illustrated in FIG. 4, the control system 10 acquires the detection signal from the sensor of the each unit of the EV pallet 1 via the interface IF1. Further, the control system 10 calculates the latitude and the longitude which is the position on the earth by the detection signal from the GPS receiving unit 1E. Further, the control system 10 acquires map data from map information database stored in the management server 3, collates the calculated latitude and longitude with the position on the map data, and acquires the current position. Further, the control system 10 determines a moving route from the current position to the delivery destination on the map data and estimates the expected arrival time to the delivery destination. Further, the control system 10 senses the obstacle around the EV pallet 1 based on signals from the obstacle sensor 18, the camera 17, or the like, determines the traveling direction to avoid the obstacle, and controls the steering angle.

Furthermore, the control system 10 links to the image processing unit 13, processes the image acquired from the camera 17 for each piece of the frame data, for example, senses a change based on the difference of the image, and recognizes the obstacle. Further, the control system 10 recognizes the user for each piece of the frame data of the image from the camera 17, keeps the distance to the user at a predetermined value, and follows the moving of the user. Further, the control system 10 recognizes a gesture of the user in the frame data of the image from the camera 17 and responds to an intention of the user obtained from the recognized gesture. Further, the control system 10 analyzes a voice signal obtained from the microphone 1F and responds to the intention of the user obtained from a voice recognition. The control system 10 may transmit the frame data of the image from the camera 17 and the voice data obtained from the microphone 1F from the communicating unit 15 to the management server 3 on the network N1. Then, an analysis of the frame data of the image and the voice data may be shared with the management server 3.

Furthermore, the control system 10 displays the images, texts, and other information on the display 16. Further, the control system 10 detects a manipulation on the display 16A with the touch panel and receives the instruction from the user. Further, from the display 16, the display 16A with the touch panel, or the speaker 10, the control system 10 responds to the instruction from the user via the display 16A with the touch panel, the camera 17, and the microphone 1F.

Upon receiving the delivery instruction of the product from the management server 3, the control system 10 causes a cooking system 1H to cook the product. At this time, the control system 10 controls the cooking system 1H based on a cooking time of the product and the expected arrival time to arrive at the delivery destination such that a cooking completion time of the product matches the expected arrival time.

In FIG. 4, the interface IF1 is exemplified, but an exchange of signals between the control system 10 and a control target is not limited to the interface IF1. That is, the control system 10 may have a plurality of signal exchange paths other than the interface IF1. Further, in FIG. 4, the control system 10 has a single CPU 11. Note that the CPU is not limited to a single processor and may have a multiprocessor configuration. Further, a single CPU connected by a single socket may have a multi-core configuration. Processing of at least a part of each of the units may be performed by a processor other than the CPU, for example, a dedicated processor such as a digital signal processor (DSP), the graphics processing unit (GPU), or the like. Further, the processing of the at least a part of each of the units may be performed by an integrated circuit (IC) or another digital circuit. Further, an analog circuit may be included in the at least a part of each of the units.

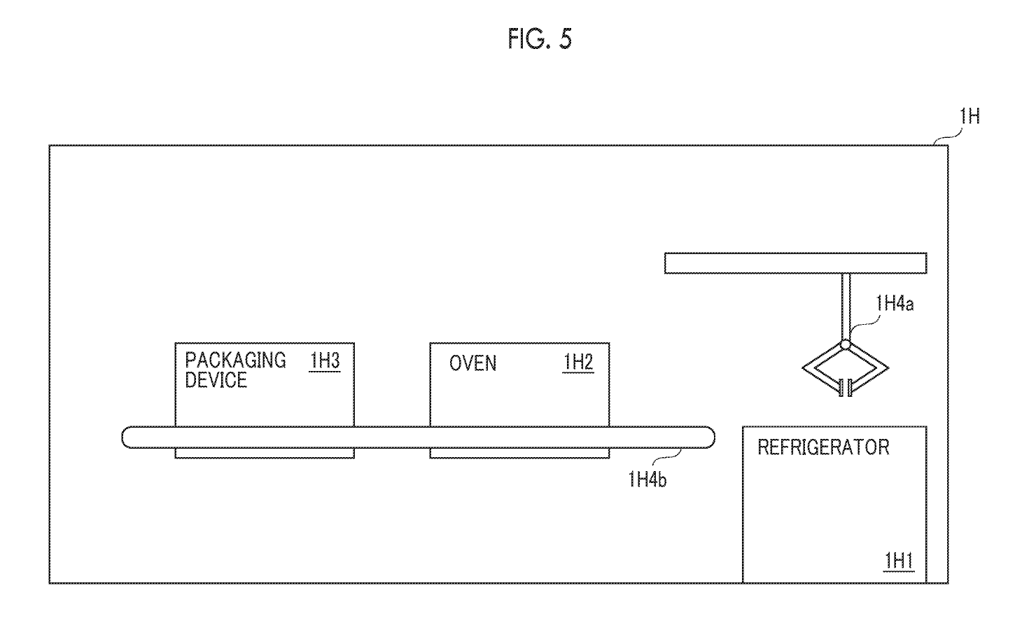

FIG. 5 is a diagram illustrating an example of the cooking system 1H mounted on the EV pallet 1. The cooking system 1H is a system that cooks the products handled by the mobile sale system according to the embodiment. Here, as an example of the cooking system 1H, a cooking system that cooks the bread will be described. The cooking system 1H has a refrigerator 1H1, an oven 1H2, a packaging device 1H3, and a conveying device 1H4. Upon receiving the delivery instruction including the type of bread, the quantity thereof, and a designation of the delivery destination from the management server 3, the EV pallet 1 estimates the expected arrival time to arrive at the delivery destination. The EV pallet 1 drives the cooking system 1H to complete the cooking of the bread of the designated type by the expected arrival time. The cooking system 1H is an example of “manufacturing means”.

The refrigerator 1H1 preserves the bread dough prepared in the processing center 4. As a temperature and humidity inside the refrigerator 1H1 is kept at the temperature and humidity suitable for preserving the bread dough, drying or spoiling of the bread dough is suppressed. In the refrigerator 1H1, a plurality of types of the bread dough such as plain loaf dough, French bread dough, or sweet buns dough is preserved. The plain loaf dough is preserved in a state of being put in a mold for the plain loaf.

The oven 1H2 bakes the bread dough conveyed from the refrigerator 1H1 to manufacture the bread. The oven 1H2 is formed in a tunnel shape, and a belt conveyor 1H4b of the conveying device 1H4 is provided to pass through the tunnel. The oven 1H2 manufactures the bread at a temperature according to the type of the bread dough. An adjustment of a heating time of the bread dough by the oven 1H2 is performed by adjusting an operation speed of the belt conveyor 1H4b. The packaging device 1H3 packages the bread cooked by the oven 1H2.

The conveying device 1H4 includes a robot arm 1H4a and the belt conveyor 1H4b. The robot arm 1H4a takes the bread dough out of the refrigerator 1H1 and places the bread dough on the belt conveyor 1H4b-1. The belt conveyor 1H4b extends from the vicinity of the refrigerator 1H1 to the packaging device 1H3 via the inside of the oven 1H2. The belt conveyor 1H4b conveys the placed bread dough to the packaging device 1H3 via the oven 1H2.

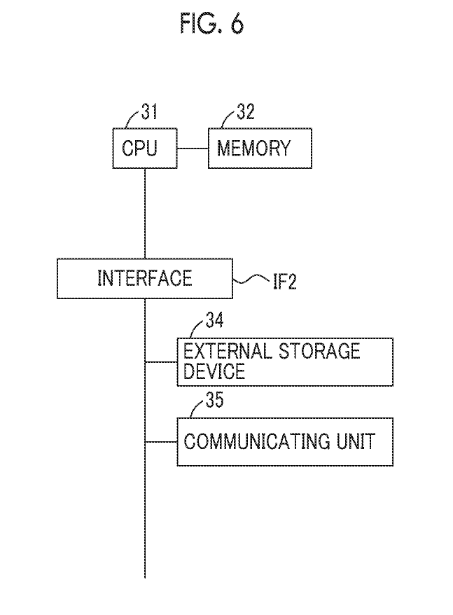

FIG. 6 is a diagram illustrating a hardware configuration of the management server 3. The management server 3 includes a CPU 31, a memory 32, an interface 1F2, an external storage device 34, and a communicating unit 35. The configurations and operations of the CPU 31, the memory 32, the interface IF2, the external storage device 34, and the communicating unit 35 are similar to those of the CPU 11, the memory 12, the interface IF1, the external storage device 14, and the communicating unit 15 in FIG. 4. Further, the configuration of the user device 2 is also similar to that of the management server 3 in FIG. 6. Note that the user device 2 may include, for example, the touch panel as an input unit on which user's manipulation is performed. Further, the user device 2 may include the display and the speaker as an output unit that provided the user with the information.

Logical Configuration

The logical configurations of the EV pallet 1 and the management server 3 of which the device configurations have been described above will be described below.

Logical Configuration of EV Pallet 1

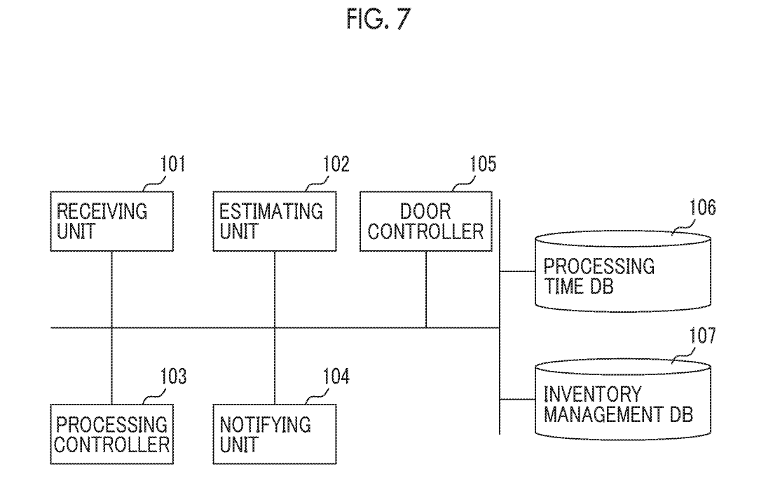

FIG. 7 is a block diagram illustrating the logical configuration of the EV pallet 1. The EV pallet 1 operates as each part of a receiving unit 101, an estimating unit 102, a processing controller 103, a notifying unit 104, a door controller 105, a processing time database 106, and an inventory management database 107 exemplified in FIG. 7, by the computer program in the memory 12. In FIG. 7, the database is indicated by DB.

The receiving unit 101 receives the delivery instruction from the management server 3. The receiving unit 101 extracts the information indicating the ordered product and the information indicating the delivery destination from the delivery instruction. The information indicating the product includes the type and the quantity of the product. The information indicating the delivery destination is, for example, the latitude and longitude indicating the delivery destination. The receiving unit 101 is an example of the “receiving means”.

The estimating unit 102 calculates the latitude and the longitude indicating the current position by the detection signal from the GPS receiving unit 1E. Further, the estimating unit 102 acquires the map data from the map information database stored in the management server 3 and determines the moving route from the current position to the delivery destination designated by the delivery instruction. The estimating unit 102 estimates the expected arrival time to arrive at the delivery destination in a case of moving to the delivery destination according to the determined moving route. Various known methods can be adopted for determining the moving route and estimating the expected arrival time. The estimating unit 102 is an example of “estimating means”.

The processing controller 103 controls a cooking start time by the cooking system 1H based on the cooking time of the product and the estimated expected arrival time. By controlling the start time of the cooking by the cooking system 1H, the manufacturing completion time of the product can be matched to the expected arrival time. That is, by the control of the processing controller 103, the manufacturing completion time of the product can be close to the expected arrival time. The processing controller 103 refers to the processing time database 106 and acquires the cooking time of the ordered product. The cooking time is, for example, the time it takes until the packaging device 1H3 completes the packaging of the cooked product after the conveying device 1H4 takes the bread dough out of the refrigerator 1H1. The processing controller 103 controls the cooking start time of the cooking system 1H such that the cooking completion time of the product and the expected arrival time match each other based on the expected arrival time and the cooking time of the product. For example, in a case where the time from the time when the moving to the delivery destination is started to the expected arrival time is longer than the cooking time, the processing controller 103 does not cause the cooking system 1H to start the cooking until the time from the current time to the expected arrival time becomes substantially equal to the cooking time. That is, while the time until the expected arrival time becomes substantially equal to the cooking time, the EV pallet 1 moves without the cooking. Thereafter, when the moving time until the expected arrival time becomes substantially equal to the cooking time, the processing controller 103 causes the cooking system 1H to start the cooking. That is, when the moving time until the expected arrival time becomes substantially equal to the cooking time, the EV pallet 1 moves to the delivery destination while cooking. More specifically, in a case where the time from the time when the moving to the delivery destination is started to the expected arrival time is 15 minutes and the cooking time is 10 minutes, the processing controller 103 causes the cooking system 1H to start the cooking five minutes after the start of moving to the delivery destination. Further, in a case where the time from the time when the moving to the delivery destination is started to the expected arrival time is shorter than the cooking time, the processing controller 103 may cause the cooking system 1H to immediately start the cooking. The processing controller 103 is an example of “controlling means”.

The notifying unit 104 notifies the management server 3 of the expected arrival time estimated by the estimating unit 102. Further, upon arriving at the delivery destination, the notifying unit 104 notifies the user device 2 of the arrival at the delivery destination. Notifying means for notifying the management server 3 and the user device 2 is not limited thereto, and it is possible to adopt various means such as an e-mail, a short message service (SMS), or a voice notification as the notifying means.

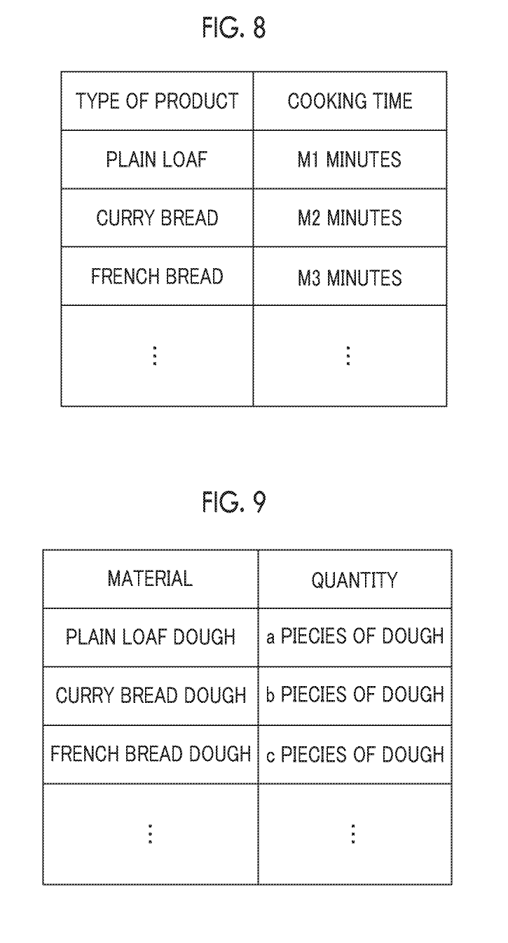

The processing time database 106 is a database that associates the product handled by the EV pallet 1 with the cooking time of the product. FIG. 8 illustrates a configuration of the cooking timetable in the processing time database 106. In FIG. 8, as an example of the cooking timetable, the cooking timetable of the EV pallet 1 that handles the bread as the product is exemplified. The cooking timetable includes the type of the product handled by the EV pallet 1 and the cooking time. In FIG. 8, each row of the table corresponds to one product type. The product type is the information indicating the type of the product handled by the EV pallet 1, and the plain loaf, the curry bread, and the French bread are exemplified as the product type in FIG. 8. The processing controller 103 can determine the manufacturing time for manufacturing the ordered product by referring to the cooking timetable based on the type of the ordered product and the quantity thereof. The processing controller 103 can determine the manufacturing completion time of the product based on the determined manufacturing time and the current time.

The door controller 105 controls an opening and closing of the door DR1. The door controller 105, for example, suppresses the opening of the door DR1 until the payment of the product price is received by the card reader CR1 and opens the door DR1 when the card reader CR1 receives the payment of the product price. When the door DR1 opens, the user can receive the product delivered by the EV pallet 1. The door controller 105 is an example of “suppressing means”.

The inventory management database 107 is a database that manages the types and quantities of the materials kept in the EV pallet 1. FIG. 9 is a table illustrating a configuration of an inventory quantity table in an inventory management database 107. In the inventory quantity table, the material of the product manufactured by the EV pallet 1 and the quantity thereof are kept. In FIG. 9, each row of the table corresponds to one material. The material is information indicating the material of the product handled by the EV pallet 1, and in FIG. 9, the plain loaf dough, the curry bread dough, and the French bread dough are exemplified as the materials.

Logical Configuration of Management Server 3

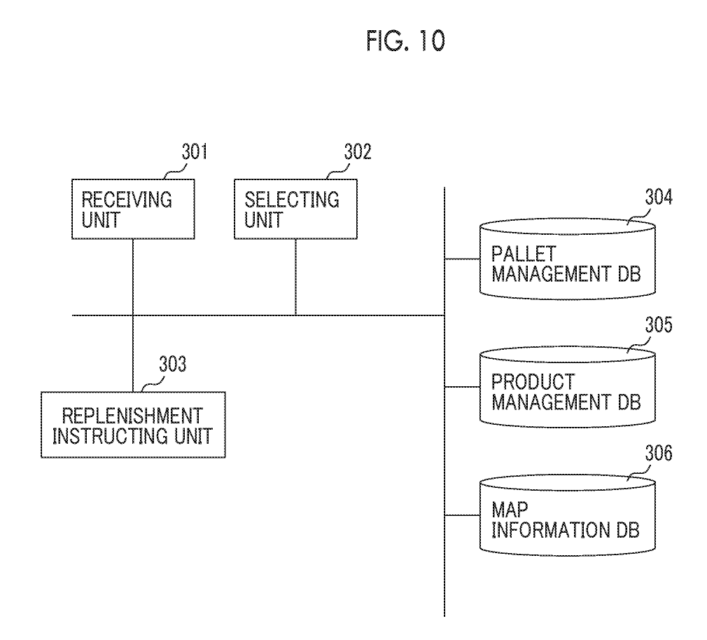

FIG. 10 is a block diagram illustrating a logical configuration of the management server 3. The management server 3 operates as each unit of a receiving unit 301, a selecting unit 302, a replenishment instructing unit 303, a pallet management database 304, a product management database 305, and a map information database 306 exemplified in FIG. 10, by a computer program in the memory 32. In FIG. 10, the database is indicated by DB.

The receiving unit 301 receives the order from the user device 2 through the communicating unit 35. As described above, the order from the user device 2 includes the information indicating the product and the information indicating the delivery destination. The receiving unit 301 extracts the information indicating the product and the information indicating the delivery destination from the received order and provides the selecting unit 302 with the extracted information. Further, upon receiving the expected arrival time from the delivery pallet, the receiving unit 301 notifies the user device 2 of the received expected arrival time and records the received expected arrival time in a delivery management table in the pallet management database 304. The receiving unit 301 is an example of “receiving means”.

The selecting unit 302 refers to the pallet management database 304, selects the delivery pallet, and provides the delivery instruction to the selected delivery pallet based on the information provided from the receiving unit 301. The delivery instruction includes the information indicating the product and the information indicating the delivery destination. The selecting unit 302 is an example of “specifying means” and “instructing means”.

The replenishment instructing unit 303 transmits a replenishment instruction to the EV pallet 1 of which the kept material has become equal to or less than the predetermined quantity to move to the processing center 4 and replenish the material. Upon receiving the replenishment instruction, the EV pallet 1 moves to the processing center 4 and receives a material replenishment.

The pallet management database 304 is a database that manages attributes of the EV pallet 1 managed by the mobile sale system of the embodiment, for example, physical parameters such as the type and dimension of the handled product, or management information of a base location.

The product management database 305 is a database that manages the products handled by the mobile sale system of the embodiment. In the product management database, a correspondence relationship between a product category which is a major category of the product, and the product type which is the type of the product included in each of the product categories is managed.

The map information database 306 is a database that stores map information in various parts of the country or around the world. The map information database 306 may be provided in the external storage device 14 of the management server 3 and may be provided in other systems connected to the network N1, for example, in a Geographic Information System (GIS). The map information database 306 includes the map data including ground object positions and data such as the texts and photographs representing the characteristic of each point on the map data.

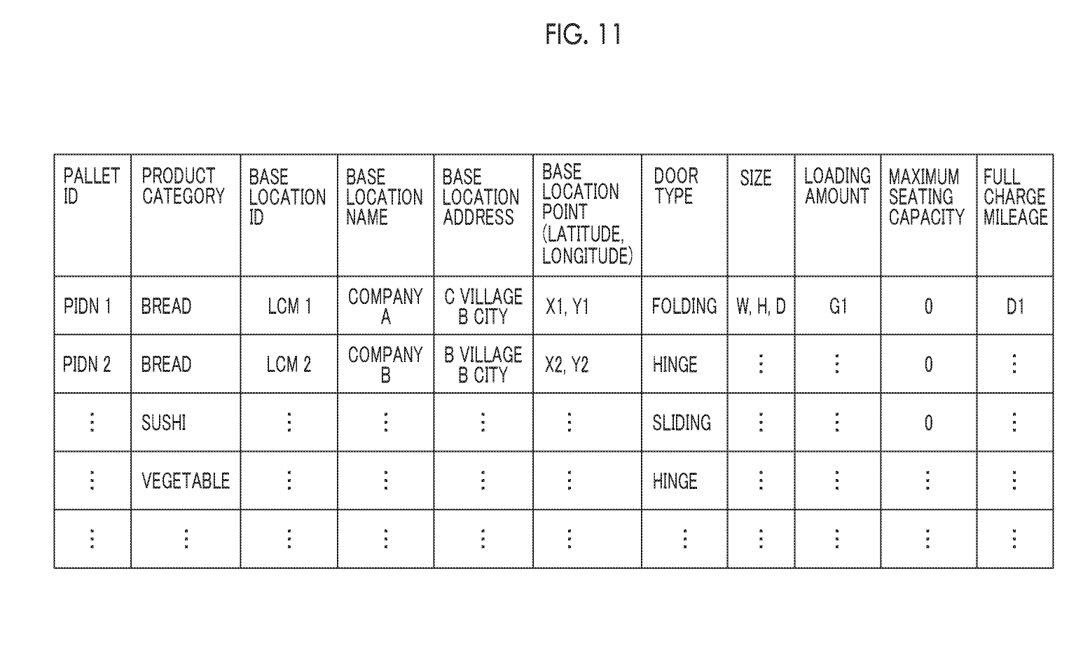

FIG. 11 is a table illustrating a configuration of a pallet management table in the pallet management database 304. The pallet management table includes the type, the physical parameters, and other characteristics of the products handled by the EV pallet 1 belonging to the mobile sale system according to the embodiment. In FIG. 11, each row of the table corresponds to one EV pallet 1. The pallet management table includes a pallet 1D, the product category, a base location ID, a base location name, a base location address, a door type, a size, a loading amount, a maximum seating capacity, and a full charge mileage in each field. The pallet management table is an example of a “management table”.

The pallet 1D is identification information for uniquely identifying the EV pallet 1 in the mobile sale system of the embodiment. The product category is information indicating category of the product handled by the EV pallet 1. The product category is, for example, “bread”, “sushi”, or “vegetables”. In FIG. 11, the product category is exemplified by a text column and may be designated by a code, the number, or the like.

The base location ID is the identification information for specifying the base location to which the EV pallet 1 returns, which has completed a delivery of the product to the user. The base location name is a name of a company as the base location or a name of an owner of the EV pallet 1. The base location address is an address of the base. The base location point is information that specifies the base location by the latitude and longitude. The door type is about the opening and closing method of the door DR1, and is, for example, “folding”, “sliding”, or “hinge”. In FIG. 11, the door type is exemplified by the text column, but may be designated by a code, a number, or the like.

The size is the dimension, the capacity, or the like of the EV pallet 1. The size is designated by, for example, a width (W), a height (H), and a depth (D). Note that the size, for example, may be specified by a volume of the EV pallet 1 (for example, cubic meter). The loading amount is a weight that can be mounted on the EV pallet 1. The maximum seating capacity is the number of persons who can board the EV pallet 1. The full charge mileage is a distance by which the EV pallet 1 can travel when the secondary battery 1D is fully charged.

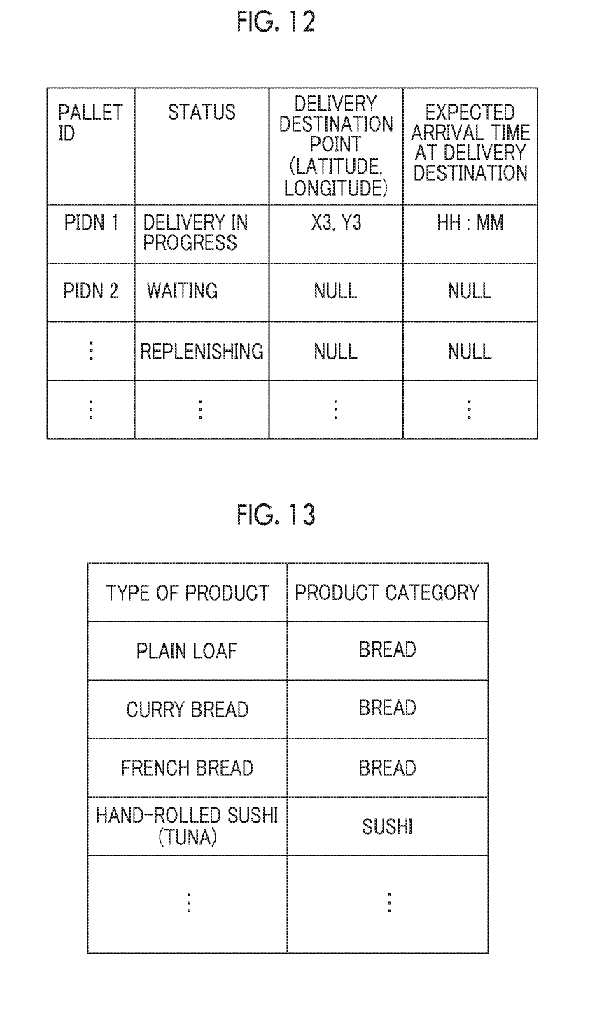

FIG. 12 is a table illustrating a configuration of the delivery management table in the pallet management database 304. The delivery management table includes a delivery status of the EV pallet 1 belonging to the mobile sale system of the embodiment. In FIG. 12, each row of the table corresponds to the one EV pallet 1. The delivery management table includes fields of the pallet 1D, a status, a delivery destination point, and the expected arrival time at the delivery destination.

The pallet 1D of the delivery management table is the identification information for identifying the EV pallet 1 for a rent management target and is the same information as the pallet 1D defined in the pallet management table. The status is information indicating whether or not the EV pallet 1 is delivery in progress. In FIG. 12, statuses of “delivery in progress” indicating that the product is being delivered, “waiting” indicating a state in which neither the material replenishment nor the delivery of the product is performed, and “replenishing” indicating a state in which the material replenishment is being performed in the processing center 4 are respectively illustrated as examples. The delivery destination point is information for specifying the delivery destination designated by the user by the latitude and longitude. The expected arrival time at the delivery destination is information indicating the expected time for the EV pallet 1 to arrive at the delivery destination, and the expected arrival time received from the selected EV pallet 1 is stored.

FIG. 13 is a table illustrating a configuration of the product management table in the product management database 305. The product management table includes the product type and the product category in association with each other. In FIG. 13, it can be seen that, for example, the product category of the “plain loaf”, the “curry bread”, the “French bread” which are in the product type is the “bread”, and the product category of the “hand-rolled sushi (a tuna)” in the product type is the “sushi”.

Screen Transition

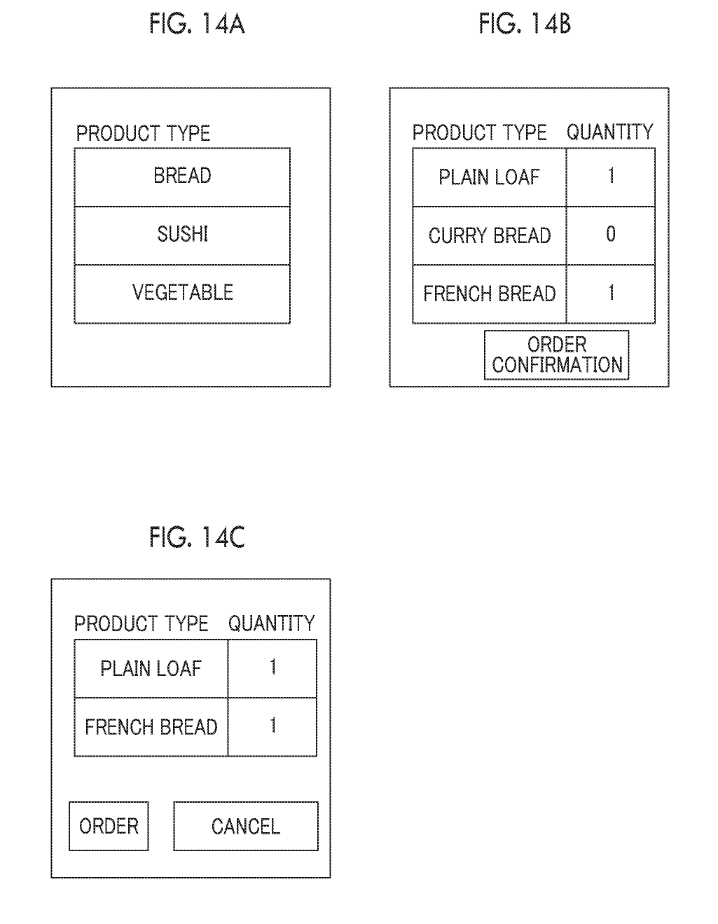

The user using the mobile sale system according to the embodiment orders the product by manipulating the user device 2. FIG. 14A to 14C are diagrams each illustrating an example of a screen transition of the user device 2 at the time of the product order. Hereinafter, with reference to FIGS. 14A to 14C, an example of the screen transition of the user device 2 at the time of the product order will be described.

FIG. 14A to 14C illustrates examples of a screen for selecting the product category. When the user orders the product, for example, as exemplified in FIG. 14A, a list of the product categories handled in the mobile sale system according to the embodiment is displayed on the user device 2. In FIG. 14A, when the user selects a desired product category by manipulation of touching or the like, the screen transits to FIG. 14B. Here, it is assumed that the bread is selected as the product category on the screen illustrated in FIG. 14A. On the screen illustrated in FIG. 14B, the list of the product types included in the product category selected in FIG. 14A is displayed. When the desired product type and the quantity thereof are designated and an order confirmation button is pressed in FIG. 14B, the screen transits to FIG. 14C. FIG. 14C is an example of a confirmation screen of the ordered product. When an order button is pressed in FIG. 14C, an order content is transmitted to the management server 3. The order content transmitted to the management server 3 includes information indicating the product category, the product type and the quantity thereof, and the latitude and longitude indicating the current position calculated by the GPS device included in the user device 2. Upon receiving the order from the user device 2, the management server 3 selects the delivery pallet as described above, and the selected delivery pallet delivers the product.

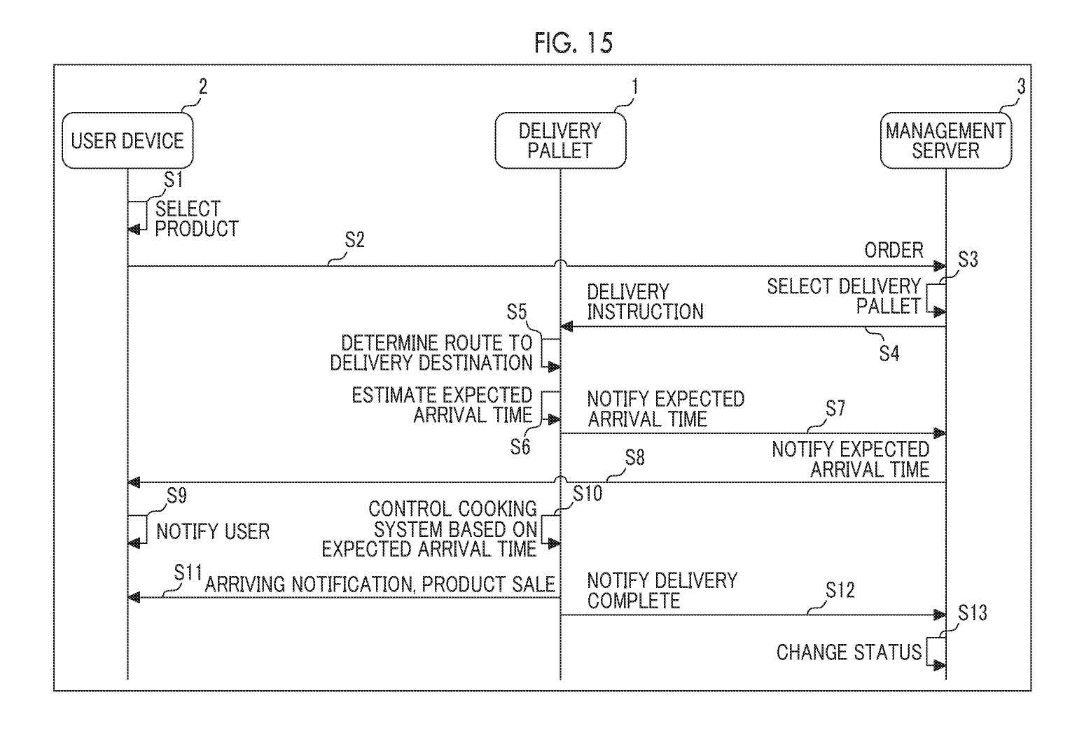

FIG. 15 is a diagram illustrating an example of a processing sequence of the mobile sale system according to the embodiment. Hereinafter, the processing sequence of the mobile sale system according to the embodiment will be described with reference to FIG. 15.

In S1, the selection of the product by the user is performed on the user device 2. For example, the user device 2 displays the screen exemplified in FIGS. 14A to 14C and the selection of the product is performed by the user's manipulation on the displayed screen. In S2, the user device 2 orders the product to the management server 3. The product order is performed, for example, by pressing the order button on the screen exemplified in FIG. 14C described above. In the product order, the user device 2 transmits order information including the information indicating the product and the information indicating the delivery destination to the management server 3.

In S3, the receiving unit 301 of the management server 3 receives the order information from the user device 2. The receiving unit 301 extracts the information indicating the product and the information indicating the delivery destination from the order information and provides the selecting unit 302 with the extracted information. The selecting unit 302 refers to the pallet management database 304 and the product management database 305 and selects the delivery pallet based on the information provided by the receiving unit 301. The selecting unit 302 preferentially selects the EV pallet 1 that is waiting or replenishing from among the EV pallets 1 that handle the ordered product. In a case of no delivery pallet in waiting or replenishing, the selecting unit 302 preferentially selects the pallet as the delivery pallet among the EV pallets 1 of delivery in progress of which the expected arrival time at the delivery destination is closest to the current time.

More specifically, in a case where the ordered product is the curry bread, the selecting unit 302 refers to the product management table in the product management database 305 and grasps that the product category of the “curry bread” in the product type is the “bread”. Further, the selecting unit 302 refers to the pallet management table in the pallet management database 304 and extracts the EV pallet 1 of which the product category is the bread. In a case where the pallet management table in the pallet management database 304 is in the state illustrated in FIG. 11, the selecting unit 302 extracts the EV pallets 1 having the pallet IDs “PIDN1” and “PIDN2” as the EV pallet of which the product category is the bread. Further, the selecting unit 302 refers to the delivery management table in the pallet management database 304 and preferentially selects the EV pallet 1 that is waiting or replenishing from among the extracted EV pallets 1 as the delivery pallet. In a case where the delivery management table in the pallet management database 304 is in the state illustrated in FIG. 12, the selecting unit 302 selects the EV pallet 1 having the pallet 1D “PIDN2” as the delivery pallet. In S4, the selecting unit 302 provides the delivery instruction to the EV pallet 1 having the pallet 1D “PIDN2” selected in S3. Further, in the delivery management table in the pallet management database 304, the selecting unit 302 changes the status of the EV pallet indicated by the pallet 1D “PIDN2” to the “delivery in progress”.

In S5, the estimating unit 102 of the delivery pallet which has received the delivery instruction extracts the information indicating the delivery destination from the delivery instruction and determines the moving route from the current position to the delivery destination. In S6, the estimating unit 102 estimates the expected arrival time in a case of moving to the delivery destination according to the moving route. In S7, the estimating unit 102 notifies the management server 3 of the expected arrival time. In S8, the receiving unit 301 of the management server 3 notifies the user device 2 of the expected arrival time notified from the delivery pallet and records the expected arrival time in the delivery management table in the pallet management database 304. In S9, the user device 2 notifies the user by outputting the notified expected arrival time to the display or the like of the user device 2.

In S10, the processing controller 103 of the delivery pallet controls the cooking system 1H such that the manufacturing completion time of the product and the expected arrival time at the delivery destination match each other. The processing controller 103 controls the time at which the cooking system 1H starts the cooking, for example, according to the time from the receiving of the delivery instruction to the expected arrival time at the delivery destination. By controlling the time at which the cooking system 1H starts the cooking, the manufacturing completion time of the product can be matched to the expected arrival time. When the cooking system 1H uses the material, the processing controller 103 subtracts the quantity of the used material from the quantity of the material before the using of the material in the inventory quantity table in the inventory management database 107.

In S11, the delivery pallet arrives at the delivery destination. The notifying unit 104 of the delivery pallet notifies the user device 2 that the delivery pallet has arrived at the delivery destination. The user inserts a credit card into the card insertion slot of the card reader CR1 of the delivery pallet. The card reader CR1 reads the information on the credit card inserted in the card insertion slot and performs the payment processing of the product price. Upon completing the payment processing by the card reader CR1, the delivery pallet opens the door DR1 by the door controller 105, and the product is handed over to the user. That is, the door controller 105 suppresses the handing over of the product to the user without the opening the door DR1 until the payment processing by the card reader CR1 is completed. Upon handing over the product to the user, the delivery of the product is completed.

In S12, the notifying unit 104 of the delivery pallet which has completed the delivery of the product in S11 notifies the management server 3 of a delivery completion. In S13, the management server 3 changes the status of the delivery pallet in the delivery management table in the pallet management database 304 from the “delivery in progress” to the “waiting”. In the embodiment, since the delivery pallet selected in S3 is the EV pallet 1 having the pallet 1D “PIDN2”, the status of the EV pallet 1 having the pallet 1D “PIDN2” is changed from the “delivery in progress” to the “waiting”.

In a case where a quantity of a material indicated by the inventory quantity table in the inventory management database 107 is equal to or less than the predetermined quantity due to a sale of the products, at the timing of S12, the notifying unit 104 of the delivery pallet notifies the management server 3 that the material replenishment is needed. The replenishment instructing unit 303 of the management server 3 transmits a replenishment instruction to the delivery pallet to move to the processing center 4 and to replenish the material. The replenishment instruction may include information indicating a location of the processing center 4 capable of replenishing the material that needs to be replenished. Further, in S13, the replenishment instructing unit 303 changes the status of the delivery pallet in the delivery management table in the pallet management database 304 to the “replenishing” from the “waiting”. The delivery pallet instructed to replenish moves to the processing center 4 and receives the replenishment of the material prepared in the processing center 4.

### Operational Effect of Embodiment

In the embodiment, the estimating unit 102 of the delivery pallet estimates the expected arrival time at the designated delivery destination. The processing controller 103 of the delivery pallet can control the start time of the cooking by the cooking system 1H such that the manufacturing completion time of the bread and the expected arrival time match each other. Therefore, according to the embodiment, it is possible to deliver fresh-baked bread which is not cooked in advance to the user waiting at the delivery destination.

Further, in the embodiment, in a case where the time from the time when the moving to the delivery destination is started to the expected arrival time is shorter than the cooking time, the processing controller 103 immediately causes the cooking system 1H to start the cooking. Since the cooking of the bread is performed while the delivery pallet is moving, it is possible to reduce a waiting time of the user as compared with a case of the cooking after arrival at the delivery destination.

Further, in the embodiment, the door controller 105 suppresses the opening of the door DR1 until the payment processing by the card reader CR1 is completed. Therefore, according to the embodiment, it is possible to suppress the non-payment of the price.

### First Modification Example

Although the case of mobile sale of the bread in the embodiment has been described in detail, the mobile sale system can also be applied to the products other than the bread. Hereinafter, a description will be made on a case of handling sushi, fish, vegetables, plants, or the like as the product other than the bread.

Case of Handling of Sushi as Product

In a case of handling the sushi as the product, for example, the refrigerator preserving sushi materials and a sushi robot shaping sushi rice and putting the sushi material taken out of the refrigerator on the sushi rice are mounted on the EV pallet 1. The processing controller 103 may control the sushi robot such that the manufacturing completion time of the sushi and the expected arrival time match each other. The manufacturing time of the sushi may be determined, for example, by storing the manufacturing time per unit of the sushi in the cooking timetable in the processing time database 106 and referring to the cooking timetable based on an ordered quantity. The processing controller 103 can determine the manufacturing completion time of the sushi based on the determined manufacturing time and the current time. As the manufacturing completion time of the sushi and the expected arrival time match each other, drying of the sushi material or the like due to an elapse of a long time after a completion of the sushi can be suppressed. That is, according to such a modification example, the user can be provided with the high-quality sushi.

Case of Handling Processed Product of Fish as Product

Further, in a case of handling the processed product of the fish as the product, for example, a fish tank and a fish processing device are mounted on the EV pallet 1. The fish is kept alive in the fish tank, and the fish processing device is a device that processes the fish taken out of the fish tank. The fish processing device performs processing such as cutting the fish into three fillets or into slices for sashimi. The processing time until the completion of the fish processing may be determined by storing, for example, the processing time for each of the fish processing types (the above-mentioned cutting the fish into three fillets or into slices for sashimi, or the like) in the cooking timetable of the processing time database 106 and referring to the cooking timetable based on the processing type of the ordered fish and the quantity thereof. The processing controller 103 can determine the processing completion time of the fish based on the determined processing time and the current time. The processing controller 103 may control the fish processing device such that the processing completion time of the fish and the expected arrival time match each other. As the processing completion time of the fish and the expected arrival time match each other, it is possible to provide the processed product of fish to the user in a fresh state.

Case of Handling Plants Such as Vegetable and Cut Flower as Product

In a case of handling the plants such as vegetables and cut flower as the product, for example, a small farm and a harvesting device that harvests the plant from the small farm are mounted on the EV pallet 1. The harvesting time until completion of the harvest may be determined by storing, for example, the harvesting time for one plant in the cooking timetable in the processing time database 106 and referring to the cooking timetable based on the quantity of the ordered plant. The processing controller 103 can determine a harvesting completion time of the plant based on the determined harvesting time and the current time. The processing controller 103 controls the harvesting device such that the harvesting completion time of the plant and the expected arrival time match each other. The user can be provided with the fresh plant by controlling the harvesting device in this manner. As the harvesting completion time and the expected arrival time match each other, wilting of the plants due to the elapse of the time from the harvest can be suppressed. Further, in a case of handling the cut flowers as the product, the harvesting device may harvest the cut flower by cutting the flowers growing in the small farm.

### Second Modification Example

In the embodiment, information between the user device 2 and the EV pallet 1 is exchanged through the management server 3. That is, in the embodiment, the management server 3 which has received the order from the user device 2 transmits the order information to the selected delivery pallet based on the order contents. Further, upon receiving the expected arrival time from the delivery pallet, the management server 3 transmits the expected arrival time to the user device 2. However, the exchange of the information between the user device 2 and the EV pallet 1 is not limited to the exchange through the management server 3. For example, the user device 2 may transmit the product order to the EV pallet 1, and the EV pallet 1 may transmit the expected arrival time to the user device 2.

### Third Modification Example

In the embodiment, as the processing controller 103 controls the start time of the cooking by the cooking system 1H, the completion time of the product and the expected arrival time match each other. However, the control of matching the completion time of the product and the expected arrival time is not limited thereto. The processing controller 103 may match the completion time of the product to the expected arrival time by extending or shortening the time to be spent on respective steps of cooking steps. For example, the processing controller 103 may extend the cooking time by lowering a temperature of the oven 1H2 and extending the heating time or may shorten the cooking time by increasing the temperature of the oven 1H2 and shortening the heating time. The relationship between the temperature of the oven 1H2 and the heating time may be determined such that the baking loss rate falls within the desired range suitable for the type of the bread (for example, about 8% to 10% for the plain loaf and about 22% for the French bread), for example. The baking loss rate indicates a proportion of moisture lost from the bread dough during the cooking in the oven 1H2 and is calculated by subtracting the weight after the cooking by the oven 1H2 from the weight before the cooking by the oven 1H2, dividing the difference by the weight before the cooking by the oven 1H2, and multiplying the quotient by 100. Although the cooking time by the oven 1112 is changed, the change in the texture of the bread can be suppressed by considering the baking loss rate of the bread. The cooking step is an example of “manufacturing step”.

### Other Modification Example

In the embodiment, since the EV pallet 1 cooks the number of the ordered product, which is equal the ordered quantity, the EV pallet 1 does not keep the inventory. However, the EV pallet 1 may manufacture the product so as to keep a certain quantity of the inventory. In this case, for example, the EV pallet 1 may display the type and the quantity of the inventory kept in on the display 16 fixed to the outer wall of the EV pallet 1. It is possible to make the product appeal to the user to buy by displaying the inventory and the quantity on the display 16. Further, the expected manufacturing completion time of the product may be displayed on the display 16. By displaying such information on the display 16, for example, it is possible to provide the user or the person around the EV pallet 1 with the information on the products handled by the EV pallet 1 and make the user or the person around the EV pallet 1 want to buy the product. The display 16 is an example of “displaying means”.

In the embodiment, the current position acquired by the user device 2 using the GPS is designated as the delivery destination, but the designation of the delivery destination is not limited thereto. The user may designate any place by manipulating the user device 2 for designating the delivery destination. For example, in a case where the user is planning to move to a certain place, a designation of the place to go as the delivery destination makes it convenient to receive the product.

In the embodiment, the payment of the product price is performed by the credit card, but the product price may be paid by other means such as cash, an electronic money card, and a debit card. Further, instead of providing the payment means exemplified by the card reader CR 1 in the EV pallet 1, the payment means such as credit card information of the user may be registered in advance in the management server 3, and the payment of the product price may be realized by using the payment means registered by the management server 3 when the product order is received.

In an embodiment, the EV pallet 1 notifies the management server 3 that the material replenishment is needed, moves to the processing center 4 upon receiving the replenishment instruction from the management server, and the material replenishment is performed. In the EV pallet 1, however, in a case where the material replenishment is needed, the EV pallet 1 may move to the processing center 4 and receive the material replenishment without depending on the instruction from the management server 3.

In the embodiment, the estimation of the expected arrival time is performed by the control system 10 of each EV pallet 1, but a configuration may be adopted, in which each EV pallet 1 transmits the position information to the management server 3, and the management server 3 estimates the expected arrival time of the each EV pallet 1. Further, in S10 of the above embodiment, the processing controller 103 of the delivery pallet may calculate the control contents for controlling the cooking system 1H such that the manufacturing completion of the product and the expected arrival time at the delivery destination match each other. Alternatively, in S10, the management server 3 may calculate the control contents for controlling the cooking system 1H to transmit the control contents to the delivery pallet such that the manufacturing completion of the product and the expected arrival time at the delivery destination match each other, and the processing controller 103 of the delivery pallet may control the cooking system 1H based on the control content received from the management server 3.

The embodiment and the modification examples disclosed above can be combined with each other respectively.

Computer-Readable Recording Medium

An information processing program for realizing any one of the described above functions in a computer or other machine, apparatus (hereinafter, referred to as the computer or the like) can be recorded on the recording medium that can be read by the computer or the like. Then, by causing the computer or the like to read and execute the program of the recording medium, the functions can be provided.

Here, the recording medium that can be read by the computer or the like means a recording medium that accumulates information such as data and programs by electrical, magnetic, optical, mechanical, or chemical action and that can be read by the computer or the like. Among such recording media, examples of the recording medium detachable from the computer or the like include a flexible disk, a magneto-optical disk, a Compact Disc Read Only Memory (CD-ROM), a Compact Disc-Recordable (CD-R), a Compact Disc-ReWritable (CD-RW), a Digital Versatile Disc (DVD), a Blu-ray Disc (BD), a Digital Audio Tape (DAT), 8 mm tape, and a memory card such as a flash memory. Further, examples of the recording medium fixed to the computer or the like include a hard disk, and a ROM.

What is claimed is:

1. A delivery vehicle comprising:
a moving unit configured to move the delivery vehicle from a current position to a delivery destination;
a manufacturing device configured to manufacture a product; and
circuitry configured to
receive a delivery instruction to deliver the product to the delivery destination,
acquire the current position of the delivery vehicle,
estimate an expected arrival time for the delivery vehicle to arrive at the delivery destination based on the current position and the delivery destination, and
control the manufacturing device such that the expected arrival time and a manufacturing completion time of the product match each other.

2. The delivery vehicle according to claim 1, wherein
the circuitry is configured to acquire the current position of the delivery vehicle and estimate the expected arrival time when the delivery vehicle receives the delivery instruction.

3. The delivery vehicle according to claim 1, wherein
the circuitry is configured to change a time at which the manufacturing device starts the manufacturing of the product based on a manufacturing time of the product and the expected arrival time such that the expected arrival time and the manufacturing completion time of the product match each other.

4. The delivery vehicle according to claim 1, wherein
the circuitry is configured to change a time to be spent on at least one step among product manufacturing steps such that the expected arrival time and the manufacturing completion time of the product match each other.

5. The delivery vehicle according to claim 4, wherein
the product is bread
the manufacturing device includes an oven that bakes bread dough and
the circuitry is configured to change a temperature and a cooking time of the oven for a baking loss rate of the bread dough to fall within a desired range such that the expected arrival time and the manufacturing completion time of the product match each other.

6. The delivery vehicle according to claim 1, further comprising
a payment receiving unit configured to receive a payment of a product price,
wherein the circuitry is configured to suppress a handing over of the product by the delivery vehicle until the payment receiving unit receives the payment of the product price.

7. The delivery vehicle according to claim 1, further comprising
a display configured to display at least one of information for specifying the product, an inventory quantity of the product, and an expected manufacturing completion time of the product, the display being provided on an outer wall of the delivery vehicle.

8. A mobile sale system comprising:
a server; and
one or more delivery vehicles, wherein:
the server includes
a memory that stories a management table in which a product is associated with each delivery vehicle among the one or more delivery vehicles, and
a processor configured to
receive order information including information for specifying the product and information indicating a delivery destination from a user device,
specify a delivery vehicle that handles the product specified by the order information among the one or more delivery vehicles with reference to the management table, and
transmit a delivery instruction including the order information to the specified delivery vehicle; and
each of the one or more delivery vehicles includes
a manufacturing device configured to manufacture the product,
a moving unit configured to move the delivery vehicle from a current position to the delivery destination,
a receiving unit configured to receive the delivery instruction, and
an electronic control unit configured to
acquire the current position of the delivery vehicle after the delivery instruction is received,
estimate an expected arrival time for the delivery vehicle to arrive at the delivery destination based on the current position and the delivery destination, and
control the manufacturing device such that the expected arrival time and a manufacturing completion time of the product match each other.

9. A mobile sale management method executed by a delivery vehicle and a server, the delivery vehicle including a manufacturing device configured to manufacture a product, the server being configured to receive order information including information for specifying the product and information indicating a delivery destination from a user device and to communicate with the delivery vehicle, the mobile sale management method comprising:
(a) acquiring a current position of the delivery vehicle;
(b) estimating an expected arrival time for the delivery vehicle to arrive at the delivery destination based on the current position and the delivery destination;
(c) causing the delivery vehicle to move to the delivery destination; and
(d) providing the manufacturing device with information for controlling the manufacturing device such that the expected arrival time and a manufacturing completion time of the product match each other.

10. The mobile sale management method according to claim 9, wherein
the steps (a), (b), and (d) are executed by an electronic control unit mounted on the delivery vehicle.

11. The mobile sale management method according to claim 9, wherein
the steps (a), (b), and (d) are executed by an electronic circuit provided in the server.
